(19) United States
(12) Patent Application Publication
(10) Pub. No.: US 2018/0308251 A1
(43) Pub. Date: Oct. 25, 2018

(54) METHOD FOR RECOGNIZING THE POSITION OF OBJECTS

(71) Applicant: Pepperl+Fuchs GmbH, Mannheim (DE)

(72) Inventor: Till STEINER, Mannheim (DE)

(73) Assignee: Pepperl+Fuchs GmbH, Mannheim (DE)

(21) Appl. No.: 15/957,115

(22) Filed: Apr. 19, 2018

(30) Foreign Application Priority Data
Apr. 21, 2017 (DE) 10 2017 108 524.6

(51) Int. Cl. G06T 7/73; G06K 9/20; B07C 5/34

(52) U.S. Cl. CPC G06T 7/74; G06T 2207/30204; B07C 5/3412; G06K 9/2063

(57) ABSTRACT

A method for recognizing the position of objects includes the following consecutive steps. In a first step, multiple objects having at least one distinctive component are provided. In a second step, a first object is transported to a measuring station having at least one ultrasonic sensor. In a third step, the object is measured using ultrasound. The ultrasonic waves are reflected by the object, recorded again by the at least one ultrasonic sensor and converted to electrical signals. In a fourth step, the electrical signals from the region where the distinctive component is disposed are transmitted to an artificial intelligence, and then converted to an image. In a last step, the obtained image is compared with a reference image, wherein it is checked whether the distinctive component is situated in the evaluated region. If so, the object is in the correct position.

### CROSS REFERENCE TO RELATED APPLICATIONS

Applicant claims priority under 35 U.S.C. § 119 of German Application No. 10 2017 108 524.6 filed Apr. 21, 2017, the disclosure of which is incorporated by reference.

### BACKGROUND OF THE INVENTION

### 1. Field of the Invention

The invention relates to a method for recognizing the position of objects.

### 2. Description of the Related Art

So that objects can be packaged or installed into an apparatus, they must be in a specific position. For this purpose, the technique of image recognition has been used for many years. Because objects can look completely different from different perspectives and under different lighting, object recognition by means of image recognition proves to be extremely difficult and is supported by artificial intelligence (AI). A further problem is represented by the separation of object, light effects, and background. For this purpose, very powerful computers and programs are used, which make it possible to differentiate between object and background. In this regard, the image recognition methods work with image databases, which they search for comparable patterns.

Once these objects have been identified, the objects that are not in the correct position can be sorted out.

From EP 3 029 486 A1, a method and an apparatus for object recognition by means of ultrasound are known, wherein the method has a learning phase and a recognition phase that follows the learning phase in terms of time. In the learning phase, a plurality of ultrasonic receivers receives ultrasonic waves, which were or are emitted by at least one ultrasonic transmitter and reflected on at least one object to be recognized during the recognition phase. Feature vectors are obtained from the ultrasonic waves received during the learning phase and are stored in a memory device.

In the recognition phase, the plurality of ultrasonic receivers receives ultrasonic waves, which were or are emitted by the at least one ultrasonic transmitter and reflected on the at least one object to be recognized during the recognition phase. Feature vectors are obtained from the ultrasonic waves received during the recognition phase and are compared, at least in part, with feature vectors stored in memory during the learning phase. The recognition of an object then takes place by means of minimization of a distance dimension defined within the space of the feature vectors, between at least one feature vector of an object to be recognized during the recognition phase and at least one feature vector stored in memory during the learning phase.

Furthermore, a method for object recognition by means of ultrasound, by means of ultrasonic transducers or transducer groups is known (cf. Vossiek M., Mágori V.: Objekterkennung mit Ultraschall [Object Recognition with Ultrasound] in: Tränkler H R., Reindl L. (eds) Sensortechnik [Sensor Technology]. VDI Book. Springer Vieweg, Berlin, Heidelberg. 2014. pp 1403-1448). In this method, position recognition is evaluated by means of difference profiles using a comparison with patterns by means of fuzzy logics in the sense of artificial intelligence.

### SUMMARY OF THE INVENTION

It is an object of the present invention to make available a method for recognizing the position of objects, in which method it can be determined, using computers having only low computing power, whether or not an object is in the correct position.

These and other objects are accomplished in accordance with the invention.

The invention therefore relates to a method for recognizing the position of objects, comprising the following consecutive steps. In a first step (Step 1.1), multiple objects are made available, which have at least one distinctive component. This distinctive component is situated in a specific region of the object, wherein more than just one distinctive component can also be present in this region. In a second step (Step 1.2), this object is transported to a measuring station, in which at least one ultrasonic sensor is disposed in a fixed position. In a third step (Step 1.3), the object is measured by means of ultrasound, wherein the ultrasonic waves are reflected by every object. These ultrasonic waves are recorded again by the at least one ultrasonic sensor and converted to electrical signals. In a fourth step (Step 1.4), the electrical signals are made available to an artificial intelligence. In this regard, only the signals received from the specific region of the object are evaluated and ultimately converted to an image. In a final step (Step 1.5), the image of the region that is obtained is compared with a reference image, wherein it is checked whether or not the at least one distinctive component is situated in the region that was evaluated. This artificial intelligence can be a computer, for example, even a simple personal computer (PC), for example.

An advantage of this method is that multiple objects can be measured by means of ultrasound during the shortest possible period of time. In this regard, it is not necessary to evaluate the electrical signals received from the entire object, but rather only that region of the object in which the distinctive component, which serves as a marker, is supposed to be situated.

If this marker is not situated in the region that was evaluated, the object is not in the correct position, so that the object is sorted out. The objects that are in the correct position are passed on to a processing station, in which the objects can be installed into an apparatus. For example, these objects are circuit boards that are installed in a sensor.

It is advantageous, in this regard, that measuring of the objects, evaluation of the electrical signals, and comparison of the individual images of the objects with the reference image can take place very rapidly, without this artificial intelligence having to demonstrate great computing power or the software being used having to be very powerful. This feature particularly arises because not all the electrical signals need to be evaluated, but rather only those signals that were obtained from a specific region of the object. For this reason, even a simple PC can be used as the artificial intelligence.

In an advantageous embodiment, a second object is transported to the measuring station and also measured, and it is checked whether or not this object has a marker in the region that was evaluated or, in the event that multiple markers are provided in the region, all these markers are contained in the region.

So as to be able to pass the second object to the measuring station quickly, it is advantageous if a transport apparatus, for example a conveyor belt configured as an endless belt, is made available, which belt continuously transports the objects to the measuring station. As soon as the second object has been measured, it is moved out of the measuring station again. A third object is then passed to the measuring station, so as to be measured in the measuring station.

It is advantageous, in this regard, that the different objects can be measured very quickly, one after the other.

Preferably, the objects are transported to a sorting-out system, in which sorting out of those objects, the image of which does not agree with the reference image, takes place. In this regard, sorting out can take place automatically, for example by means of a robot, or by hand. In this way, it is guaranteed that only those objects that have the correct position are processed further. For further processing, the objects are passed to a processing station in which they are either packaged or processed further. If these objects are processed further in the processing station, the objects can be installed into an apparatus, for example. For example, these objects can be circuit boards that are either packaged or installed into a sensor.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a top view of an object with a marker;

FIG. 2 is a perspective view of a measuring station, as well as a transport apparatus by means of which objects are transported into the measuring station; and

FIG. 3 is a view of an interior of the measuring station shown in FIG. 1.

### DETAILED DESCRIPTION OF PREFERRED EMBODIMENTS

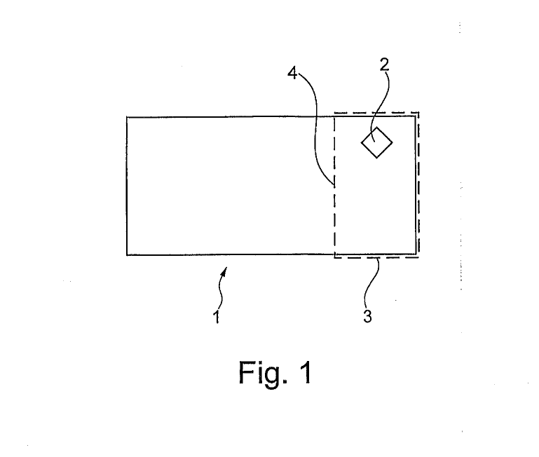

In FIG. 1, a top view of an object 1, shown schematically, is shown, which object has a marker 2. This marker 2 is a distinctive component, a perforation or a borehole, wherein this marker 2 is situated in a defined region 3 of the object 1. The region 3 is indicated with a broken line 4. It is also possible, however, that this marker 2 is technically irrelevant and serves only for position recognition of the object 1, for example because it has a particularly distinctive structure.

These objects 1 can be, for example, a circuit board or any other component. It is understood that multiple markers can also be present in the region of the object, on the basis of which markers it can be determined whether or not the object is in the correct position.

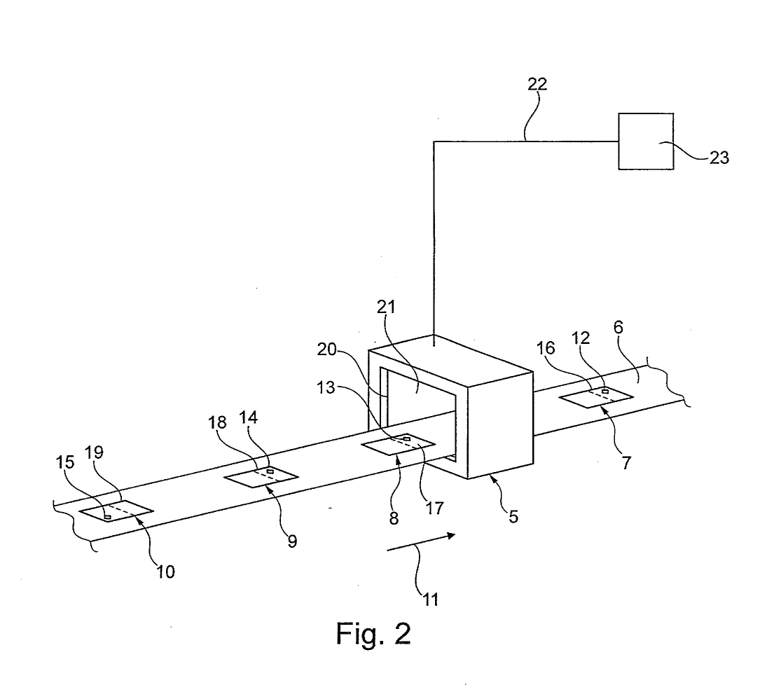

FIG. 2 shows a perspective view of a measuring station 5 as well as a transport apparatus 6, by means of which the objects can be transported into the measuring station 5 for measuring. In FIG. 2, the transport apparatus 6 is configured as a transport belt, but only parts of this belt are shown. Multiple objects 7 to 10 are disposed on the transport apparatus 6, which objects are transported in the direction of the arrow 11, i.e. into the measuring station 5 and out of it again. All the objects 7 to 10 possess a marker 12 to 15. Preferably, these markers 12 to 15 are a technically relevant component, a perforation or a borehole. In the case of the objects 7 to 9, the markers are disposed in a region 16 to 18, which is situated in the front section of the object. In the case of the object 10, in contrast, the marker 15 is situated in a region that is situated not in the front region 19 but rather in the rear region of the object 10. In the case of this exemplary embodiment, the objects 7 to 10 are measured in the measuring station 5 by means of ultrasound, and only the region 16 to 19 in the front section of the objects 7 to 10 is evaluated. Because the marker 15 of the object 10 is not situated in the region 19 that is being evaluated, the object 10 is therefore not in the desired position.

The object 7 was already measured and moved out of the measuring station 5 again, while the objects 8 to 10 still have to be measured and therefore still have to be transported into the measuring station 5. For this purpose, the objects 8, 9, and 10 can get into an interior 21 of the measuring station 5 by way of an opening 20. Once the objects have been measured, they get back out of the measuring station 5 by way of an opening that lies opposite the opening 20 and cannot be seen in FIG. 2. So as to be able to measure the objects 7 to 10 in the measuring station 5 by means of ultrasound, the measuring station 5 has at least one ultrasonic sensor disposed in a fixed position. If a more precise image of the objects is supposed to be obtained, the measuring station 5 can also have more than just one ultrasonic sensor, for example two to eight ultrasonic sensors. Thus, the measuring station 5 also has multiple ultrasonic sensors, but these sensors cannot be seen in FIG. 2 because they are situated in the interior of the measuring station 5.

The measuring station 5 is connected with an artificial intelligence 23, preferably a computer, by way of at least one electrical connection 22. The artificial intelligence 23 and the electrical connection 22 are shown only schematically. In this regard, the electrical connection 22 can consist of multiple lines, so that the electrical connection 22 can be a line run.

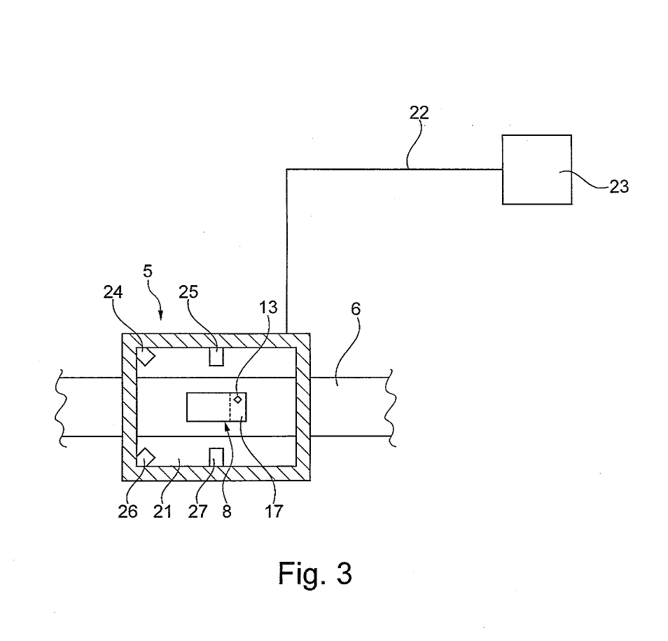

In FIG. 3, the interior 21 of the measuring station 5 shown in FIG. 2 can be seen, wherein the view is from above onto the transport apparatus 6. The object 8 has already been transported into the measuring station 5 and is therefore situated within the measuring station 5. There, the region 17 of the object 8 is measured by means of ultrasound. For this purpose, four ultrasonic sensors 24 to 27, which emit ultrasonic waves, are provided in the measuring station 5. For this purpose, alternating voltage is applied to a transducer (which also cannot be seen) of each ultrasonic sensor 24 to 27, during the ultrasonic measurement, wherein the transducer is preferably a piezoelectric quartz or ceramic oscillator. The transducer is excited by application of the alternating voltage and produces oscillations, so that ultrasonic waves are formed, which are emitted by every ultrasonic sensor 24 to 27. These ultrasonic waves, emitted by every ultrasonic sensor 24 to 27, impact the object 8 and are reflected back by the object 8. These reflected ultrasonic waves are received by the electrical transducer of each ultrasonic sensor 24 to 27 and converted to electrical signals. These electrical signals are made available to the artificial intelligence 23 by way of the electrical connection 22. In the artificial intelligence 23, these signals are subjected to an evaluation of frequency, phase, and amplitude. This evaluation takes place, however, only for those electrical signals that come from the region 17, not from the complete object. Therefore exclusively an image of the region 17 of the object 8 is obtained. This image of the region 17 is compared with a reference image. This reference image is an image of a region of a predetermined, i.e. desired object, which has the specific marker.

It is advantageous, in this regard, that the evaluation can take place very quickly, because the evaluation needs to take place only for the signals of a specific region, but not for the signals of the complete object.

Because ultrasonic measurements as such are known, these measurements will not be discussed in any further detail.

Four ultrasonic sensors disposed in a fixed position are provided in the measurement station 5. It is understood that more or fewer ultrasonic sensors disposed in a fixed position can also be provided, but at least one ultrasonic sensor must be present in order to obtain an image that can be compared with the reference image.

Although only a few embodiments of the present invention have been shown and described, it is to be understood that many changes and modifications may be made thereunto without departing from the spirit and scope of the invention.

What is claimed is:

1. A method for recognizing a position of an object comprising the following consecutive steps:
1.1 providing a plurality of objects, wherein each object has at least one marker;
1.2 transporting a first object of the plurality of objects to a measuring station where at least one ultrasonic sensor is disposed;
1.3 measuring the first object using ultrasound, wherein ultrasonic waves are reflected by the object, recorded again by the at least one ultrasonic sensor, and converted to electrical signals;
1.4 providing the electrical signals to an artificial intelligence, wherein the artificial intelligence evaluates a subset of the electrical signals received from a specific region of the object to obtain an image of the specific region; and
1.5 comparing the image of the specific region obtained with a reference image.

2. The method according to claim 1, further comprising transporting a second object of the plurality of objects to the measuring station and repeating the steps 1.3 to 1.5.

3. The method according to claim 1, wherein if the image of the first object does not agree with the reference image, the first object is sorted out in a sorting-out system, and if the image of the first object does agree with the reference image, the first object is transported to a further station.

4. The method according to claim 3, wherein the further station is a processing station and the first object is processed further in the processing station if the image of the first object agrees with the reference image.
